(19) United States
(12) Patent Application Publication
(10) Pub. No.: US 2016/0246124 A1
(43) Pub. Date: Aug. 25, 2016

(54) LIQUID CRYSTAL DISPLAY PANEL AND DISPLAY DEVICE

(71) Applicant: Shenzhen China Star Optoelectronics Technology Co., Ltd., Shenzhen, Guangdong (CN)

(72) Inventors: Peng Du, Shenzhen, Guangdong (CN); Ming Hung Shih, Shenzhen, Guangdong (CN); Chih Tsung Kang, Shenzhen, Guangdong (CN)

(21) Appl. No.: 14/418,170

(22) PCT Filed: Jan. 12, 2015
(86) PCT No.: PCT/CN2015/070509

§ 371 Date: May 9, 2016

(30) Foreign Application Priority Data
Dec. 26, 2014 (CN) 201410837422.4

(51) Int. Cl. G02F 1/1343; G02F 1/1333; G02F 1/1368

(52) U.S. Cl. CPC G02F 1/134309; G02F 1/1368; G02F 1/133371; G02F 2001/134345

(57) ABSTRACT

A liquid crystal display panel and a display device are provided. The liquid crystal display panel comprises a plurality of pixel units arranged as an array. Each pixel unit comprises at least three sub pixels of different colors. In each pixel unit, a primary region of each of some of the sub pixels has a larger brightness than a secondary region thereof, and each of the rest sub pixels has a consistent brightness.

The present application claims benefit of Chinese patent application CN 201410837422.4, entitled “A Liquid Crystal Display Panel and A Display Device” and filed on Dec. 26, 2014, the entirety of which is incorporated herein by reference.

### TECHNICAL FIELD

The present disclosure relates to the technical field of display, and in particular to a liquid crystal display panel and a display device.

### TECHNICAL BACKGROUND

Flat panel display device, such as a liquid crystal display panel (LCD panel for short), has the advantages of light weight, power saving, radiation free, and the like, and thus has been gradually replacing traditional cathode ray tube (CRT) display device and becomes the mainstream display device. Currently, liquid crystal panels are widely used in various electronic equipment, such as digital television, computer, personal digital assistant, mobile phone, and digital camera, and the like.

At present, liquid crystal display devices mainly use twist nematic (TN) liquid crystal display panel, in-plane switching (IPS) liquid crystal display panel, and vertical alignment (VA) liquid crystal display panel.

The existing VA liquid crystal panel, which can satisfy the large viewing angle characteristics, suffers from low usage rate of light emitted from a backlight thereof. In order to guarantee sufficient brightness of the VA liquid crystal display device, the intensity of the light from the backlight must be enhanced, whereby the power consumption of the liquid crystal display device is increased.

### SUMMARY OF THE INVENTION

The objective of the present disclosure is to provide a liquid crystal display panel and a display device, so that the light usage rate of the VA liquid crystal display panel can be increased, and at the same time the large viewing angle characteristics thereof can be satisfied.

According to a first aspect of the present disclosure, a liquid crystal display panel is provided, comprising a plurality of pixel units arranged as an array, each pixel unit comprising at least three sub pixels of different colors, wherein in each pixel unit, a primary region of each of a part of the sub pixels has a higher brightness than a secondary region thereof, and each of the rest sub pixels has a same brightness.

Each of the rest sub pixels having the same brightness is achieved through enabling that a primary region of each of the rest sub pixels has the same brightness with a secondary region thereof.

Each pixel unit comprises three sub pixels, each having a primary region and a secondary region. A primary region of one of the three sub pixels has a same brightness with a secondary region thereof, and a primary region of each of the other two sub pixels has a larger brightness than a secondary region thereof.

Each pixel unit comprises three sub pixels, each having a primary region and a secondary region. A primary region of each of two of the three sub pixels has a same brightness with the secondary region thereof, and a primary region of the other sub pixel has a larger brightness than a secondary region thereof.

The primary region of each of a part of the sub pixels having a larger brightness than the secondary region thereof is achieved through enabling that the primary region is provided with a primary region pixel electrode and the secondary region is provided with a secondary region pixel electrode, an area ratio of the primary region pixel electrode to the primary region being larger than that of the secondary region pixel electrode to the secondary region.

The primary region of each of a part of the sub pixels having a larger brightness than the secondary region thereof is achieved through enabling that a thickness of a liquid crystal cell corresponding to the primary region is smaller than that of a liquid crystal cell corresponding to the secondary region.

The primary region of each of a part of the sub pixels having a larger brightness than the secondary region thereof is achieved through enabling that each sub pixel is provided with a first switching element corresponding to the primary region and a second switching element corresponding to the secondary region.

An area of the secondary region accounts for 60% of that of an aperture region of a sub pixel, and an area of the primary region accounts for 40% of that of the aperture region of the sub pixel.

The liquid crystals in the liquid crystal display panel are arranged in a vertical alignment mode.

The present disclosure has the following beneficial effects. According to an embodiment of the present disclosure, only a part of the sub pixels in each pixel unit each comprise a primary region and a secondary region respectively having different brightnesses, and the rest sub pixels each have the same brightness. The area of the low brightness region in each pixel unit is reduced, so that the usage ratio of light from the backlight of each pixel unit can be improved, whereby the power consumption of the backlight can be reduced. In the meantime, due to the sub pixel comprising a primary region and a secondary region of different brightnesses, the large viewing angle characteristics of the liquid crystal panel can be improved, the user experience can be enhanced, and the liquid crystal panel can be popularized.

In a second aspect of the present disclosure, a display device comprising said liquid crystal display panel is provided.

Other features and advantages of the present disclosure will be further explained in the following description and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE ACCOMPANYING DRAWINGS

In order to illustrate the technical solutions of the examples of the present disclosure more clearly, the accompanying drawings needed for describing the examples will be explained briefly. In the drawings:

FIGS. 1-4 schematically show a pixel unit,

FIG. 5 schematically shows a first cross section of a liquid crystal display panel according to an example of the present disclosure,

FIGS. 6 and 7 each schematically show a plane view of FIG. 5,

FIG. 8 shows a variant of FIG. 6,

FIGS. 9-11 schematically show a second cross section, a third cross section, and a fourth cross section of the liquid crystal display panel according to an example of the present disclosure,

FIG. 12 schematically shows a first structure of a sub pixel according to an example of the present disclosure,

FIG. 13 shows an equivalent circuit diagram of FIG. 12,

FIG. 14 shows a second structure of the sub pixel according to an example of the present disclosure, and

FIG. 15 shows an equivalent circuit diagram of FIG. 14.

### DETAILED DESCRIPTION OF THE EMBODIMENTS

The present disclosure will be explained in detail with reference to the examples and the accompanying drawings, whereby it can be fully understood how to solve the technical problem by the technical means according to the present disclosure and achieve the technical effects thereof, and thus the technical solution according to the present disclosure can be implemented. It is important to note that as long as there is no structural conflict, all the technical features mentioned in all the examples may be combined together in any manner, and the technical solutions obtained in this manner all fall within the scope of the present disclosure.

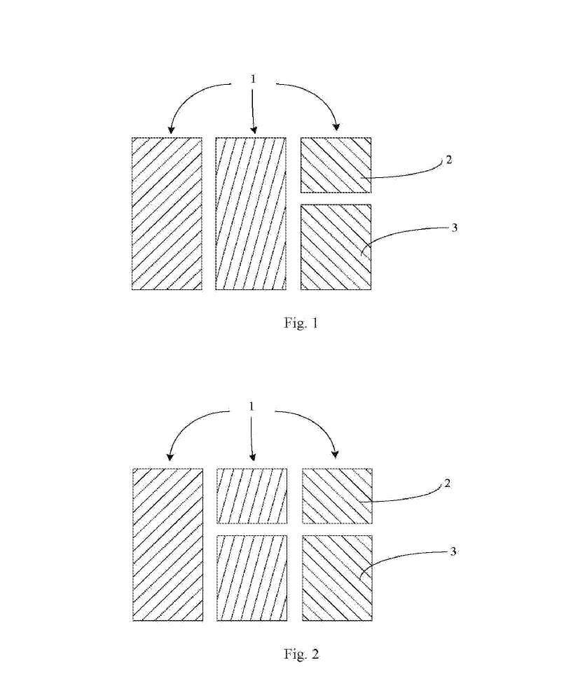

A liquid crystal display panel is provided according to an example of the present disclosure, comprising a plurality of pixel units arranged as an array. As shown in FIGS. 1 and 2, each pixel unit comprises at least three sub pixels 1 of different colors. It should be noted that in order to show that the sub pixels 1 are of different colors, these sub pixels 1 are indicated by different hatching lines in FIG. 1 and FIG. 2.

In each pixel unit, a primary region 2 of each of a part of the sub pixels 1 has a higher brightness than a secondary region 3 thereof, and a brightness over each of the rest sub pixels 1 is the same.

In a pixel unit comprising only three sub pixels 1 as shown in FIG. 1 and FIG. 2, one or two of the sub pixels is/are structured to comprise a primary region 2 and a secondary region 3 respectively having different brightnesses, and the rest sub pixel or sub pixels is/are structured as a whole and thus have the same brightness.

Color cast tends to occur to a traditional liquid crystal display panel viewed at a large viewing angle. That is, the color of an image observed by a user at large viewing angle would deviate from that observed at a center viewing angle. As shown in FIG. 3, because each sub pixel 1 in a traditional liquid crystal display panel is presented as a whole region, only the long axes, or only the short axes of the liquid crystal molecules can be seen from different angles. Due to anisotropy of liquid crystal molecules, refractive indices of the liquid crystal molecules in different directions are different. As a result, color cast of an image under large viewing angle relative to the center viewing angle would occur.

In order to alleviate color cast under a large viewing angle, in the prior art, each sub pixel 1 in a pixel unit is usually divided into a primary region 2 and a secondary region 3, as shown in FIG. 4. When the liquid crystal display panel is in operation, the primary region 2 displays higher brightness, and the secondary region 3 displays lower brightness. In this manner, the user can see the long axes of liquid crystal molecules in one of the regions while seeing the short axes of liquid crystal molecules in the other region, which provides an average effect. As a result, such average effect can be observed from every angle, whereby the large viewing angle characteristics of the liquid crystal display panel can be improved.

However, due to the relatively large area of the secondary region 3, which occupies over half of an aperture region of the entire sub pixel 1, the usage ratio of light from the backlight of the entire sub pixel 1 is reduced. In order for the backlight to provide sufficient brightness, the power consumption thereof will inevitably be increased. This is not an environment-friendly design.

According to a technical solution of an example of the present disclosure, only a part of the sub pixels in each pixel unit each have a primary region and a secondary region with different brightnesses, and the rest sub pixels each have a uniform brightness. Therefore, an area of a region with lower brightness in each pixel unit is reduced, so that the improvement of the usage ratio of light from the backlight of each pixel unit can be facilitated, whereby the power consumption of the backlight can be reduced. In the meantime, due to the sub pixel or sub pixels comprising the primary region and the secondary region with different brightnesses, the large viewing angle characteristics of the liquid crystal display panel can be improved, the user experience thereof can be enhanced, and the popularization thereof can be facilitated.

In a common liquid crystal display panel, each pixel unit comprises a red sub pixel, a green sub pixel, and a blue sub pixel. Human eyes are more sensitive to the skin color in an image displayed on the liquid crystal display panel. A color cast of skin color (usually whitened skin color) under a large viewing angle is largely caused by a blue ray from the liquid crystal display panel. Under such circumstances, in an example according to the present disclosure, a blue sub pixel should be adjusted. Preferably, a primary region 2 of each blue sub pixel has a different brightness from a secondary region 3 thereof, with the brightness of the primary region 2 being larger than that of the secondary region 3. Red sub pixels and green sub pixels each have uniform brightness. Moreover, sub pixels 1 of each color can be adjusted in a different manner as per the requests of different manufacturers. For example, if a manufacturer requires a warm-toned display effect, when a pixel is designed, both the blue sub pixel and the green sub pixel are adjusted. In other words, the green sub pixel is also divided into a primary region 2 and a secondary region 3, with the primary region 2 having a larger brightness than the secondary region 3. For another example, if a manufacturer uses purple-ish polarizer, when a pixel is designed, both the blue sub pixel and the red sub pixel can be adjusted. In other words, the red sub pixel is divided into a primary region 2 and a secondary region 3, with a brightness of the primary region 2 being larger than that of the secondary region 3. As a result, the amount of purple light can be reduced, thereby the color cast caused by the polarizer can be compensated. As per the request of manufacturers, special circumstances, such as only the red sub pixels, or only the green sub pixels, or both the red and the green sub pixels are adjusted, might also be feasible. The present disclosure does not set limit to such circumstances.

In an example according to the present disclosure, in order to facilitate the manufacturing of an array substrate, a pixel unit comprising a red sub pixel, a blue sub pixel, and a green sub pixel can have a structure as shown in FIG. 4, i.e., sub pixels 1 each comprise a primary region 2 and a secondary region 3. However, a primary region 2 of one of the three sub pixels 1 can have a same brightness as a secondary region 3 thereof, while a primary region 2 of each of the other two sub pixels 1 has a larger brightness than a secondary region 3 thereof, so that the usage ratio of light from a backlight of the array substrate can be improved. Alternatively, a primary region 2 of each of two of the three sub pixels 1 can have a same brightness as a secondary region 3 thereof, and a primary region of the other sub pixel 1 has a larger brightness than a secondary region 3 thereof. Specifically, the light exit conditions of the primary region 2 and the secondary region 3 of each sub pixel 1 should be configured according to actual situation, to which the present disclosure sets no limit.

Preferably, an area of the secondary region 3 accounts for 60% that of an aperture region of the sub pixel, and an area of the primary region 2 accounts for 40% that of the aperture region of the sub pixel. That is, an area ratio of the secondary region 3 to the primary region 2 is 6:4. Based on different requirements for display, the area ratio of the secondary region 3 to the primary region 2 can also be 5:5 or 4:6, to which the present disclosure sets no limit.

Further, in an example according to the present disclosure, a sub pixel is divided into a primary region 2 and a secondary region 3, the primary region 2 having a larger brightness than the secondary region 3. The sub pixel can have a structure selected from, but not limited to, the following structures.

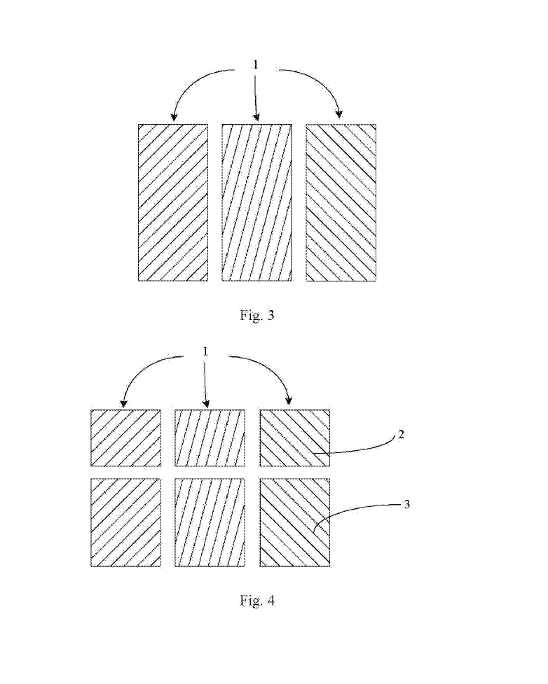

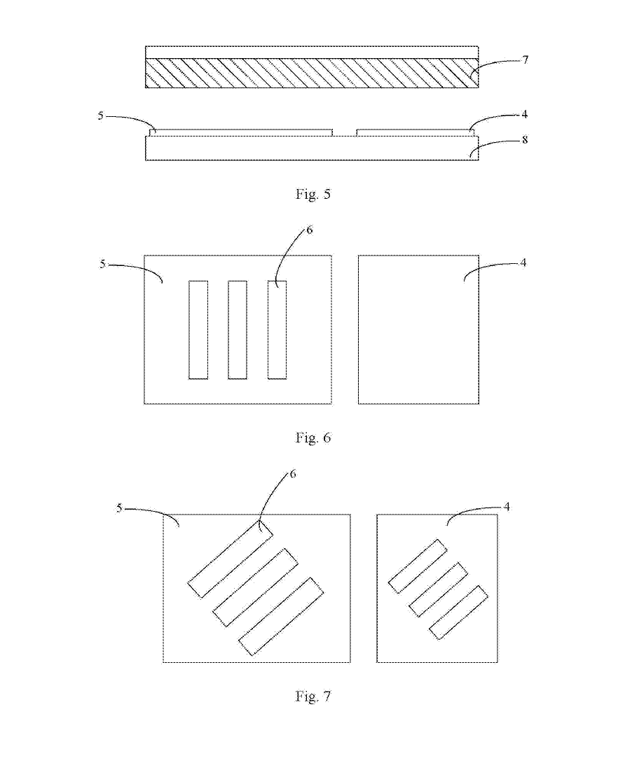

A first structure is as shown in FIGS. 5 and 6. A primary region 2 comprises a primary region pixel electrode 4, and a secondary region 3 comprises a secondary region pixel electrode 5. An area ratio of the primary region pixel electrode 4 to the primary region 2 is larger than that of the secondary region pixel electrode 5 to the secondary region 3.

As shown in FIG. 5, a thickness of a liquid crystal cell corresponding to the primary region 2 and that of a liquid crystal cell corresponding to the secondary region 3 are the same. In this case, in order for the primary region 2 to have a larger brightness than the secondary region 3, an area of the secondary region pixel electrode 5 can be reduced. Specifically, as shown in FIG. 6, the primary region pixel electrode 4 is presented as a tabular whole, while the secondary region pixel electrode 5 has a plurality of cutouts 6, which render the secondary region pixel electrode 5 and the secondary region 3 to have relatively small areas. In this case, even if the primary region pixel electrode 4 and the secondary region pixel electrode 5 in the same sub pixel 1 have the same potential, a capability of the primary region 2 to drive the liquid crystals is larger than that of the secondary region 3, because the area ratio of the primary region pixel electrode 4 to the primary region 2 is larger than that of the secondary region pixel electrode 5 to the secondary region 3. As a result, the primary region pixel electrode 4 can better drive the liquid crystals into deflection, so that the brightness of the primary region 2 can be larger than that of the secondary region 3.

In addition, if the liquid crystals in the liquid crystal display panel are arranged in a manner of vertical alignment, i.e., the liquid crystal display panel is a VA display panel, the primary region pixel electrode 4 and the secondary region pixel electrode 5 each are provided with a plurality of parallel cutouts 6 arranged in a certain angle. In order to guarantee that the capability of the primary region 2 to drive the liquid crystals is larger than that of the secondary region 3, the size of the cutouts 6 of the primary region pixel electrode 4 should be smaller than that of the cutouts 6 of the secondary region pixel electrode 5. As shown in FIG. 7, a length of each cutout 6 in the primary region 2 is smaller than that of the cutout 6 in the secondary region 3, while a width of the cutout 6 in the primary region 2 is smaller than that of the cutout 6 in the secondary region 3. As a result, the capability of the primary region 2 to drive the liquid crystals is larger than that of the secondary region 3, thereby the brightness of the primary region 2 can be larger than that of the secondary region 3.

Apparently, in the structure as shown in FIG. 7, it is also feasible that the length of each cutout 6 in the primary region 2 is smaller than that of the cutout 6 in the secondary region 3, while the width of the cutout 6 in the primary region 2 is the same as that of the cutout 6 in the secondary region 3. Alternatively, the width of the cutout 6 in the primary region 2 can be smaller than that of the cutout 6 in the secondary region 3, while the length of the cutout 6 in the primary region 2 is the same as that of the cutout 6 in the secondary region 3. Specifically, the capability of the primary region 2 to drive the liquid crystals and that of the secondary region 3 should be arranged and adjusted according to actual situation, and the present disclosure does not set limit thereto.

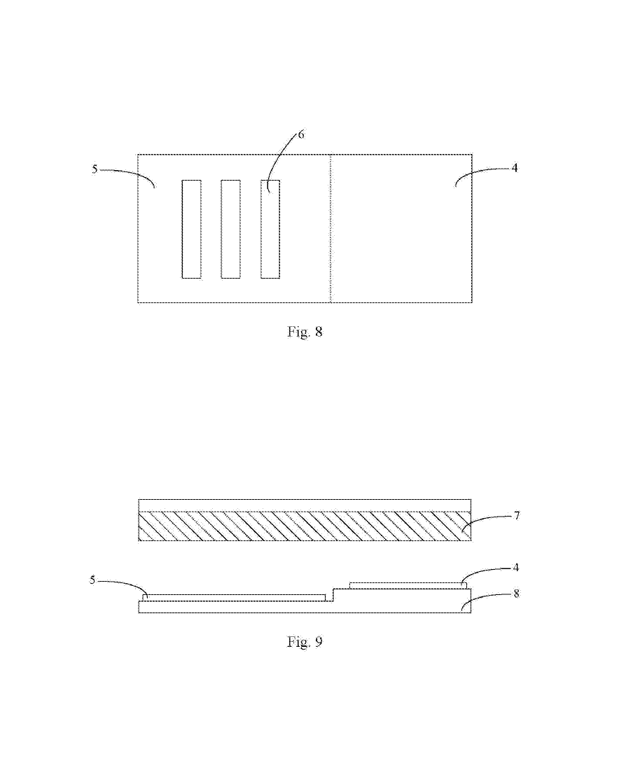

It should be noted that the primary region pixel electrode 4 and the secondary region pixel electrode 5 as shown in FIG. 6 can be structured as one-piece, as shown in FIG. 8, as long as the area ratio of the primary region pixel electrode 4 to the primary region 2 is larger than that of the secondary region pixel electrode 5 to the secondary region 3. The structure as shown in FIG. 7 can also be adjusted as such, thus will not be described in detail.

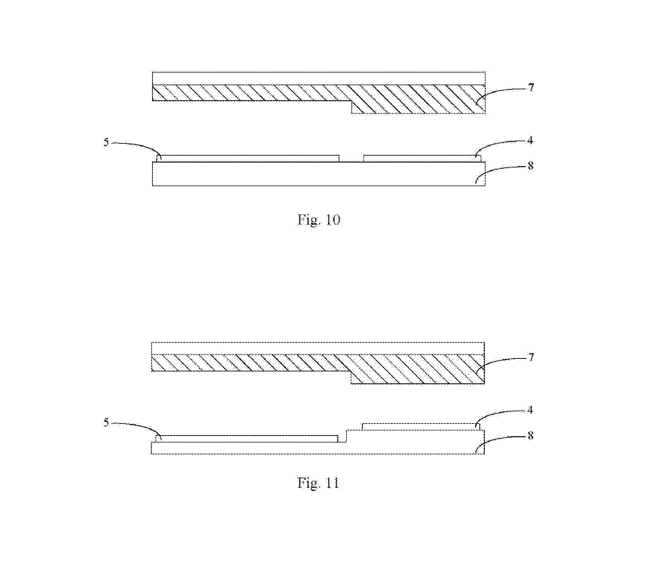

A second structure is as shown in FIG. 9. A thickness of a liquid crystal cell corresponding to a primary region 2 is smaller than that of a liquid crystal cell corresponding to a secondary region 3. In other words, a distance between a primary region pixel electrode 4 and a color filter layer 7 on a color filter substrate is smaller than that between a secondary region pixel electrode 5 and the color filter layer 7. If, at this moment, the capability of the primary region 2 to drive the liquid crystals is the same as that of the secondary region 3, because the thickness of the liquid crystal cell corresponding to the primary region 2 is smaller than that of the liquid crystal cell corresponding to the secondary region 3, the angle of deflection of the liquid crystals in the liquid crystal cell corresponding to the secondary region 3 is smaller than that corresponding to the primary region 2, whereby the brightness of the primary region 2 can be larger than that of the secondary region 3.

Specifically, in order for the thickness of the liquid crystal cell corresponding to the primary region 2 to be smaller than that corresponding to the secondary region 3, a thickness of an insulation layer 8 or each of insulation layers 8 corresponding to the primary region 2, such as an insulation layer 8 under the primary region pixel electrode 5, can be increased. Alternatively, an insulation layer 8 corresponding to the secondary region 3 can be reduced, forming a stepped structure between the primary region 2 and the secondary region 3 as shown in FIG. 9.

Furthermore, the second structure can also be realized by increasing a thickness of the color filter layer 7 corresponding to the primary region 2, or reducing a thickness of the color filter layer 7 corresponding to the secondary region 3. In this case, the color filter layer 7 is presented as a stepped structure as shown in FIG. 10.

It should be noted that the abovementioned four structures with adjustable liquid crystal cell thickness can exist simultaneously. For example, as shown in FIG. 11, while the thickness of the insulation layer 8 corresponding to the primary region 2 is increased, that of the color filter layer 7 corresponding thereto can also be increased. Any structure, in which the thickness of the liquid crystal cell corresponding to the primary region 2 is smaller than that of the liquid crystal cell corresponding to the secondary region 3, can be applied to the present disclosure.

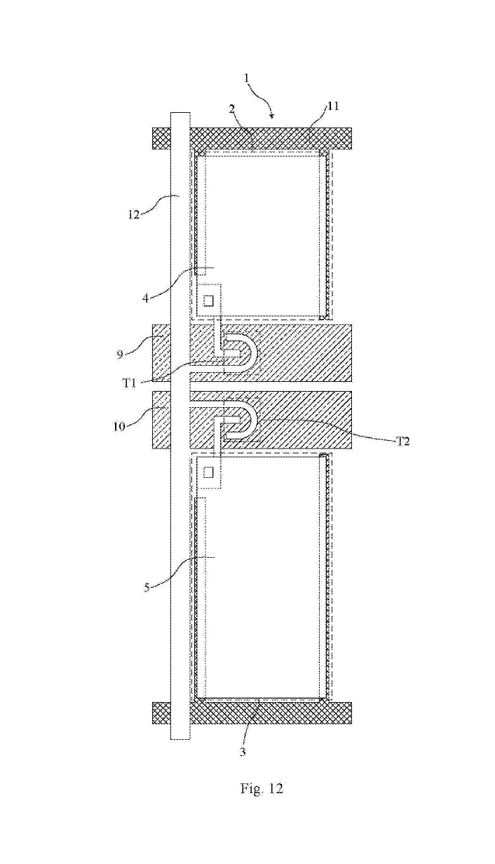

A third structure is as shown in FIG. 12. A sub pixel 1 comprising a primary region 2 and a secondary region 3 is provided with a first switching element T1 and a second switching element T2. The first switching element T1 corresponds to the primary region 2 and the second switching element T2 corresponds to the secondary region 3.

Specifically, as shown in FIG. 12, a first gate line (Gate1) 9, a second gate line (Gate2) 10, a common electrode line (Com) 11, and a data line (Data) 12 are arranged corresponding to each sub pixel 1. The first gate line 9, the second gate line 10, and the common electrode line 11 are disposed in the same layer, thus can be formed in the same patterning process. The first gate line 9 and the second gate line 10 are arranged in parallel between the primary region 2 and the secondary region 3, and the first gate line 9 corresponds to the first switching element T1 of the primary region 2 and the second gate line 10 corresponds to the second switching element T2 of the secondary region 3. T1 and T2 are preferably thin film transistors (TFTs). A gate of T1 is connected with the first gate line 9, a source thereof is connected with the data line 12, and a drain thereof is connected with the primary region pixel electrode 4. A gate of T2 is connected with the second gate line 10, a source thereof is connected with the data line 12, and a drain thereof is connected with the secondary region pixel electrode 5.

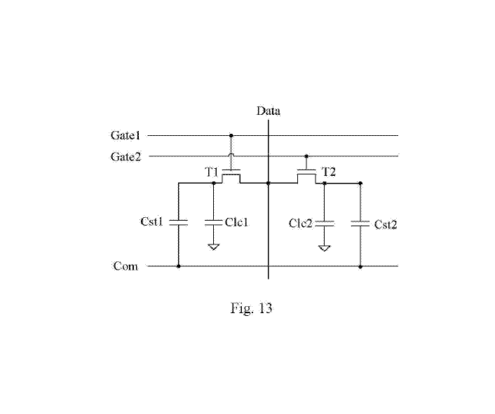

The primary region pixel electrode 4 can form a primary region liquid crystal capacitor Clc1 with a common electrode (not shown) on a color filter substrate, and an overlap section between the primary region pixel electrode 4 and the common electrode line 11 forms a primary region storage capacitor Cst1. The secondary region pixel electrode 5 can form a secondary region liquid crystal capacitor Clc2 with the common electrode (not shown) on the color filter substrate, and an overlap section between the secondary region pixel electrode 5 and the common electrode line 11 forms a secondary region storage capacitor Cst2. That is, the structure of the sub pixel as shown in FIG. 12 can be equivalent to the circuit diagram as shown in FIG. 13.

In the structure as shown in FIG. 12, during display, the first gate line 9 receives a gate drive signal, and then the corresponding T1 is turned on. T1 receives a data signal from the data line 12, and transmits the data signal to the drain thereof through an active layer, which is disposed inside T1 and connects the source and the drain of T1, so that the primary region pixel electrode 4, which is connected with the drain of T1, has a potential, and an electric field in Clc1 can drive the liquid crystal molecules to deflect. Then, the gate drive signal of the first gate line 9 blacks out, and the second gate line 10 receives a gate drive signal. In a similar manner, the second gate line 10 enables Clc2 to drive the liquid crystal molecules to deflect. The data signal transmitted through the data line 12 should enable the electric field of Clc1 to have larger intensity than that of Clc2, i.e., the volt of the data signal transmitted to T1 is larger than that transmitted to T2, whereby the brightness of the primary region 2 can be larger than that of the secondary region 3.

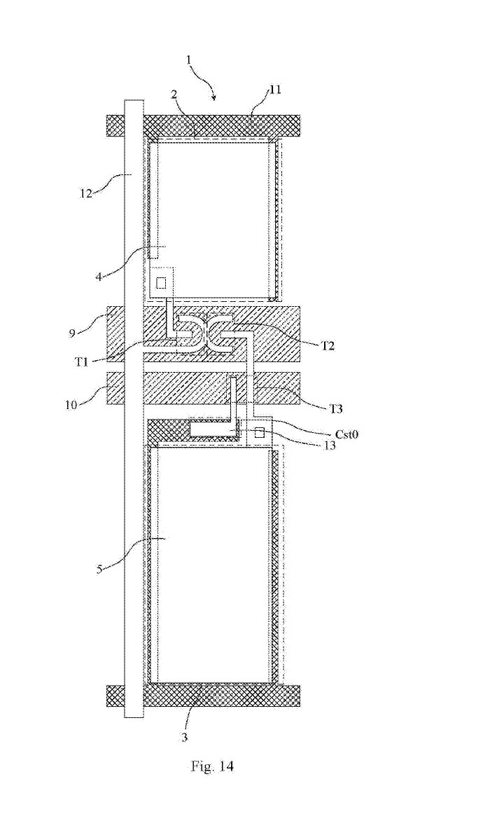

Further, as shown in FIG. 14, except for the first switching element T1 and the second switching element T2, a third switching element T3 can be further arranged in each sub pixel 1. The third switching element T3 is preferably a thin film transistor. Similar to FIG. 12, a first gate line (Gate1) 9, a second gate line (Gate2) 10, a common electrode line (Com) 11, and a data line (Data) 12 are arranged corresponding to each sub pixel 1. The difference of FIG. 14 from FIG. 12 lies in that each sub pixel 1 is further provided with a voltage dividing electrode 13. An overlap section between the voltage dividing electrode 13 and the common electrode line 11 forms a voltage dividing capacitor Cst0. The first gate line 9, the second gate line 10, and the common electrode line 11 are disposed in the same layer, thus can be formed in the same patterning process. The data line 12 and the voltage dividing electrode 13 are disposed in the same layer, thus can be formed in the same patterning process.

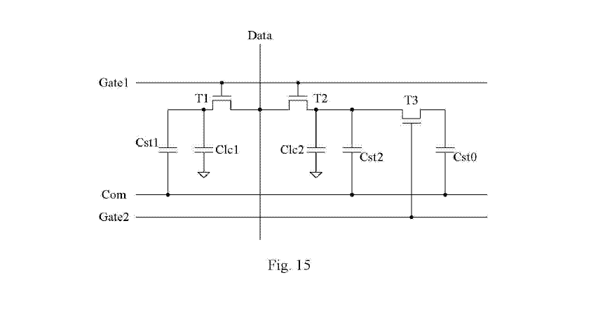

Specifically, as shown in FIG. 14, both gates of T1 and T2 are connected with the first gate line 9, both sources thereof are connected with the data line 12, and drains of T1 and T2 are respectively connected with the primary region pixel electrode 4 and the secondary region pixel electrode 5. A gate of T3 is connected with the second gate line 10, a source thereof is connected with the secondary region pixel electrode 5, and a drain thereof is connected with the voltage dividing electrode 13. Similarly to FIG. 12, in the structure as shown in FIG. 14, the primary region pixel electrode 4 can form a primary region liquid crystal capacitor Clc1 with a common electrode (not shown) on a color filter substrate, and an overlap section between the primary region pixel electrode 4 and the common electrode line 11 forms a primary region storage capacitor Cst1. The secondary region pixel electrode 5 can form a secondary region liquid crystal capacitor Clc2 with the common electrode (not shown) on the color filter substrate, and an overlap section between the secondary region pixel electrode 5 and the common electrode line 11 forms a secondary storage capacitor Cst2. That is, the structure of the sub pixel as shown in FIG. 14 can be equivalent to the circuit diagram as shown in FIG. 15.

In the structure as shown in FIG. 14, in the process of display, the first gate line 9 receives a gate drive signal first, and then corresponding T1 and T2 are turned on. T1 and T2 receive a data signal from the data line through the sources thereof, and transmit the data signal respectively to the primary region pixel electrode 4 and the secondary region pixel electrode 5, so that Clc1, Cst1, Clc2, and Cst2 all have the same voltage. Then, the gate drive signal of the first gate line 9 blacks out, and the second gate line 10 receives the gate drive signal. At this moment, T1 and T2 are turned off, and T3 is turned on, so that Cst0 can divide a part of the data signal from the secondary region pixel electrode 5 through T3. In this case, the potential of the secondary region pixel electrode 5 is reduced, thereby the voltage of Clc2 and that of Cst2 are both reduced while the voltage of Clc1 and that of Cst1 remain the same. As a result, the voltage of Clc2 is substantially lower than that of Clc1, thereby the brightness of the secondary region 3 can be lower than that of the primary region 2.

It should be noted that the abovementioned three structures can be combined in any manner. Any structure of the liquid crystal display panel, in which the brightness of the primary region 2 is larger than that of the secondary region 3, can be applied to the present disclosure.

Further, a display device is comprises the above liquid crystal display panel provided according to the present disclosure. The display device can be a liquid crystal television, a liquid crystal display device, a cell phone, or a tablet PC.

The above embodiments are described only for better understanding, rather than restricting, the present disclosure. Any person skilled in the art can make amendments to the implementing forms or details without departing from the spirit and scope of the present disclosure. The scope of the present disclosure should still be subjected to the scope defined in the claims.

### LIST OF REFERENCE SIGNS

1: sub pixel
2: primary region
3: secondary region
4:pixel electrode of the primary region
5: pixel electrode of the secondary region
6: cutout
7: color filter layer
8: insulation layer
9: first gate line
10: second gate line
11: common electrode line
12: data line
13: voltage dividing electrode

1. A liquid crystal display panel, comprising a plurality of pixel units arranged as an array, each pixel unit comprising at least three sub pixels of different colors,
wherein in each pixel unit, a primary region of each of a part of the sub pixels has a higher brightness than a secondary region thereof, and each of the rest sub pixels has a same brightness.

2. The liquid crystal display panel according to claim 1, wherein each of the rest sub pixels having the same brightness is achieved through enabling that a primary region of each of the rest sub pixels has the same brightness with a secondary region thereof.

3. The liquid crystal display panel according to claim 2, wherein each pixel unit comprises three sub pixels, each having a primary region and a secondary region, and
a primary region of one of the three sub pixels has a same brightness with a secondary region thereof, and a primary region of each of the other two sub pixels has a larger brightness than a secondary region thereof.

4. The liquid crystal display panel according to claim 2, wherein each pixel unit comprises three sub pixels, each having a primary region and a secondary region, and
a primary region of each of two of the three sub pixels has a same brightness with the secondary region thereof, and a primary region of the other sub pixel has a larger brightness than a secondary region thereof.

5. The liquid crystal display panel according to claim 1, wherein the primary region of each of a part of the sub pixels having a larger brightness than the secondary region thereof is achieved through enabling that the primary region is provided with a primary region pixel electrode and the secondary region is provided with a secondary region pixel electrode, an area ratio of the primary region pixel electrode to the primary region being larger than that of the secondary region pixel electrode to the secondary region.

6. The liquid crystal display panel according to claim 1, wherein the primary region of each of a part of the sub pixels having a larger brightness than the secondary region thereof is achieved through enabling that a thickness of a liquid crystal cell corresponding to the primary region is smaller than that of a liquid crystal cell corresponding to the secondary region.

7. The liquid crystal display panel according to claim 1, wherein the primary region of each of a part of the sub pixels having a larger brightness than the secondary region thereof is achieved through enabling that each sub pixel is provided with a first switching element corresponding to the primary region and a second switching element corresponding to the secondary region.

8. The liquid crystal display panel according to claim 1, wherein an area of the secondary region accounts for 60% of that of an aperture of a sub pixel, and an area of the primary region accounts for 40% of that of the aperture of the sub pixel.

9. The liquid crystal display panel according to claim 1, wherein the liquid crystals in the liquid crystal display panel are arranged in a vertical alignment mode.

10. A display device comprising a liquid crystal display panel, wherein the liquid crystal display panel comprises a plurality of pixel units arranged as an array, each pixel unit comprising at least three sub pixels of different colors,
wherein, in each pixel unit, a primary region of each of a part of the sub pixels has a higher brightness than a secondary region thereof, and each of the rest sub pixels has a same brightness.

11. The display device according to claim 10, wherein each of the rest sub pixels having the same brightness is achieved through enabling that a primary region of each of the rest sub pixels has the same brightness with a secondary region thereof.

12. The display device according to claim 11, wherein each pixel unit comprises three sub pixels, each having a primary region and a secondary region, and
a primary region of one of the three sub pixels has a same brightness with a secondary region thereof, and a primary region of each of the other two sub pixels has a larger brightness than a secondary region thereof.

13. The display device according to claim 11, wherein each pixel unit comprises three sub pixels, each having a primary region and a secondary region, and
a primary region of each of two of the three sub pixels has a same brightness with the secondary region thereof, and a primary region of the other sub pixel has a larger brightness than a secondary region thereof.

14. The display device according to claim 10, wherein the primary region of each of a part of the sub pixels having a larger brightness than the secondary region thereof achieved through enabling that the primary region is provided with a primary region pixel electrode and the secondary region is provided with a secondary region pixel electrode, an area ratio of the primary region pixel electrode to the primary region being larger than that of the secondary region pixel electrode to the secondary region.

15. The display device according to claim 10, wherein the primary region of each of a part of the sub pixels having a larger brightness than the secondary region thereof achieved through enabling that a thickness of a liquid crystal cell corresponding to the primary region is smaller than that of a liquid crystal cell corresponding to the secondary region.

16. The display device according to claim 10, wherein the primary region of each of a part of the sub pixels having a larger brightness than the secondary region thereof achieved through enabling that each sub pixel is provided with a first switching element corresponding to the primary region and a second switching element, corresponding to the secondary region.

17. The display device according to claim 10, wherein an area of the secondary region accounts for 60% of that of an aperture of a sub pixel, and an area of the primary region accounts for 40% of that of the aperture of the sub pixel.

18. The display device according to claim 10, wherein the liquid crystals in the liquid crystal display panel are arranged in a vertical alignment mode.
